(19) United States
(12) Patent Application Publication
(10) Pub. No.: US 2007/0282039 A1
(43) Pub. Date: Dec. 6, 2007

(54) Asphalt as resin replacement or colorant

(76) Inventors: Jeffrey W. Smith, Lockport, IL (US); Donn R. Vermilion, Newark, OH (US); Robert E. Quinn, Planefield, IL (US); Frederick H. Ponn, Newark, OH (US); Fawn M. Uhl, Gahanna, OH (US); Nasreen Olang, Granville, OH (US); Frank C. O'Brien-Bernini, Granville, OH (US)

Correspondence Address: OWENS CORNING, 2790 COLUMBUS ROAD, GRANVILLE, OH, 43023, US

(21) Appl. No.: 11/443,999

(22) Filed: May 31, 2006

(51) Int. Cl. C08L 95/00

(52) U.S. Cl. 524/59

(57) ABSTRACT

A compound includes a combination of materials for manufacturing a resin based product. The materials include a blend of asphalt and resin. The asphalt functions as at least one of a colorant to change the color of the product and a resin replacement to reduce the amount of resin in the product. The asphalt is included in an amount within a range of from 0.1% to 40% by weight of the compound. A pellet for use in the compound includes from 40% to 90% asphalt and from 10% to 60% resin by weight of the pellet. The asphalt has a softening point from 200° F. to 350° F.

### TECHNICAL FIELD

This invention relates in general to the field of asphalt, and in particular to the use of asphalt as a resin replacement and/or a colorant in a resin based product.

### BACKGROUND OF THE INVENTION

It is known to mold a consumable container from a composition including 40-90 wt % asphalt and 10-60 wt % polymer, as disclosed in commonly assigned U.S. Pat. Nos. 5,733,616, 5,989,662 and 6,107,373, which are incorporated herein by reference (“Asphalt Container Patents”). The container is filled with asphalt to provide an asphalt package. A purpose of the Asphalt Container Patents is to provide a consumable container generally made of asphalt which melts with the internal asphalt when heated in a normal roofing or paving operation. The asphalt package is made with a minimal amount of polymer content to provide physical properties versus an all-asphalt package. If a higher percentage of polymer is used, the molten asphalt contains too high of a polymer content for its intended purposes. The Asphalt Container Patents teach blending a more expensive polymer (EVA) with polypropylene in order to achieve the strength requirements for the container while minimizing the total amount of polymer.

It is also known to manufacture pellets from a mixture of asphalt and polymer, as taught in commonly assigned U.S. Pat. Nos. 6,069,194, 6,130,276 and 6,451,394, which are incorporated herein by reference (“Asphalt Additive Patents”). The asphalt/polymer composite pellets may contain 10-70 wt % asphalt and 30-90 wt % polymer. The purpose of the Asphalt Additive Patents is to provide a material which can be added to molten asphalt in a convenient pellet form to melt and form a skim on top of the molten asphalt in order to reduce emission of fumes. In a similar manner to the Asphalt Container Patents, the percentage polymer which is added to the molten asphalt is controlled so as to not provide an excessive amount of polymer.

A copper colored bituminous coating composition is disclosed in U.S. Pat. No. 2,886,459. The bitumen (e.g., asphalt) is used as the base or binder of the composition, not as a colorant. The copper color is obtained by incorporating into the composition aluminum flakes and a red mineral pigment.

### SUMMARY OF THE INVENTION

This invention relates to a compound comprising a combination of materials for manufacturing a resin based product. The materials in the compound include a blend of asphalt and resin. The asphalt functions as at least one of a colorant (wherein the asphalt is utilized at least in part to change the color of the product) and a resin replacement (wherein the asphalt is used at least in part to reduce the amount of resin in the product; i.e. at least a portion of the volume of the product includes asphalt as a substitute for at least a portion of the volume of the resin to make the product). The asphalt is included in an amount within a range of from about 0.1% to about 40% by weight of the compound.

In another embodiment, the invention relates to a compound comprising a combination of materials for manufacturing a resin based product. The materials include a blend of asphalt and resin. The asphalt functions as at least one of a colorant to change the color of the product and a resin replacement to reduce the amount of resin in the product. At least part of the asphalt is sourced from reclaimed asphalt roofing material.

In another embodiment, the invention relates to a compound comprising a combination of materials for manufacturing a resin based product. The materials include a blend of asphalt and resin. At least part of the asphalt and the resin are derived from pellets comprising the asphalt and the resin.

In another embodiment, the invention relates to a pellet for use in a compound comprising a combination of materials for manufacturing a resin based product. The pellet comprises from about 40% to about 95% asphalt and from about 5% to about 60% resin by weight of the pellet. The asphalt has a softening point within a range of from about 150° F. (66° C.) to about 350° F. (176° C.).

In another embodiment, the invention relates to a pellet for use in a compound comprising a combination of materials for manufacturing a resin based product. The materials include a blend of asphalt and resin. At least part of the asphalt is sourced from reclaimed asphalt roofing material.

In another embodiment, the invention relates to a composition comprising a blend of asphalt, resin and a nanomaterial.

In another embodiment, the invention relates to a composition comprising a blend of asphalt and resin, the composition having a color which is not black.

In another embodiment, the invention relates to a process of forming a resin based product. The process comprises providing pellets including asphalt and resin, using the pellets to form a compound which comprises a combination of materials for forming the product, and forming the compound into the product.

In another embodiment, the invention relates to a process of forming a resin based product. The process comprises blending resin and ground asphalt to form a compound which comprises a combination of materials for forming the product. The compound is formed into the product.

In another embodiment, the invention relates to a process of manufacturing asphalt/resin pellets. The process comprises the steps of: (a) melting asphalt; (b) mixing the molten asphalt from step (a) with resin to form a molten blend of asphalt and resin; and (c) forming the molten blend of asphalt and resin into asphalt/resin pellets.

### BRIEF DESCRIPTION OF THE DRAWINGS

FIG. 1 is a perspective view of several asphalt/resin pellets that can be made according to the invention.

FIG. 2 is a cross-sectional view of one of the asphalt/resin pellets taken along line 2-2 of FIG. 1.

### DETAILED DESCRIPTION AND PREFERRED EMBODIMENTS OF THE INVENTION

This invention relates to the use of asphalt as a resin replacement and/or a colorant in a resin based product such as a polymer based product. The asphalt is included as part of a compound for manufacturing the product. The term “compound”, as used herein, means a combination of materials useful for manufacturing a resin based product. The materials in the compound include at least a blend of asphalt and resin. The blend is sometimes in the form of a dispersion of the asphalt in the resin, or a dispersion of the resin in the asphalt, depending on the percentages used. As described below, the invention also relates to pellets for use in the compound. Optionally, the pellets and/or compound may also include one or more other materials useful in compounds for manufacturing resin based products, such as reinforcements, fillers such as calcium carbonate, talc or mica, process aids, lubes, pigments, dyes, carbon black, UV inhibitors (or UV absorbers), impact modifiers such as EVA or acrylics, compatibilizers, antioxidants, biocides, fungicides, coupling agents, fire retardants, heat stabilizers, mold release agents, surfactants, foaming agents, or any other material typically added in such a compound. In a preferred embodiment, the pellets and/or compound include at least a reinforcement material in addition to the asphalt and resin.

When the asphalt is used as a colorant in a resin based product it changes the color of the product compared to the same product without the asphalt. The use of asphalt as a colorant may provide handling and cleanliness advantages compared to the use of carbon black and certain pigments and dyes. The color of the product can be varied depending on the amount, type and properties of the asphalt. For purposes of the invention, the color will be described in terms of the well-known CIE 1976 (L* a* b*) color space which was developed by the International Commission on Illumination. The three parameters represent the lightness of the color (L*, L*=0 indicates black and L*=100 indicates white), its position between magenta and green (a*, negative values indicate green while positive values indicate magenta) and its position between yellow and blue (b*, negative values indicate blue and positive values indicate yellow). Any suitable calorimeter can be used for measuring the color, such as an X-Rite model SR62 manufactured by X-Rite Inc., Tewksbury, Mass. For purposes of the invention, the color measurement is taken on a molded resin based product having a thickness of 0.125 inch (0.318 cm).

In one embodiment of the invention, a jet black or bluish black color is considered a most desirable color, preferred for the target product applications. In this embodiment, the blend of resin and asphalt has a CIE L* color not greater than about 35, an a* color within a range of from about −10 to about 10, and a b* color within a range of from about −10 to about 10. Preferably, the blend of resin and asphalt has an L* color within a range of from about 1.5 to about 35, an a* color within a range of from about −5 to about 5, and a b* color within a range of from about −5 to about 5. Most preferably the pellets form a product that produces a good black color, such that a coupon of 0.125 inch (0.318 cm) thickness has a CIE L* color within a range of from about 24 to about 27. More preferably the L* is below 26.

Optionally, other materials may be blended with the resin and asphalt to achieve the desired black color. For example, carbon black or iron oxide black can be added. This may be included in the pellets, the compound, or added in the process to manufacture the final product.

Different colors besides black can also be achieved for the blend of resin and asphalt. The different colors can be produced by the selection of the asphalt and/or by adding other materials (herein referred to as “coloring additives”) to the resin/asphalt blend. For example, the coloring additives can include different colorants, dyes, pigments, titanium dioxide, metal flakes, fillers and/or carbon black can be added to the resin/asphalt blend to achieve different colors. Some specific examples are as follows. A white pigment or filler can be blended with the resin and asphalt to produce a gray color. Metal flake such as aluminum and a pigment such as iron oxide can be blended with the resin and asphalt to produce a red color. The resin/asphalt blend can be mixed with non-leafing grade (or hiding grade) aluminum flake to produce a gold color. The resin/asphalt blend can be mixed with non-leafing aluminum flake and green pigment to produce a green color. The resin/asphalt blend can be mixed with non-leafing aluminum flake, red pigment, and titanium dioxide to produce a light red color. The following patents and abstracts, which are incorporated by reference herein, disclose different methods of producing colored asphalts that may also be suitable for use with the resin/asphalt blends of the invention: U.S. Pat. Nos. 1,417,838; 2,223,289; 2,332,219; 2,886,459; 3,511,675; 3,567,476; 3,764,359; 4,332,620; and 4,522,655; and Japanese abstract nos. 60-133067 and 03-233005. This may be included in the pellets, the compound, or added in the process to manufacture the final product.

When the asphalt is used as a resin replacement in a resin based product it functions as a replacement for a portion of the resin in the compound for making the product. The use of asphalt in the compound may provide certain processing and product property benefits as discussed below. The right selection of the amount, type and properties of the asphalt can produce a product which substantially retains its physical properties compared to the same product without the asphalt as a resin replacement. In one embodiment, when the asphalt is included in an amount within a range of from about 0.1% to about 5% by weight of the product, the product retains at least about 90% of the following physical properties: tensile stress, tensile modulus, flex stress RT, flex stress 0° F. (−18° C.), flex modulus RT, and flex modulus 0° F. (−18° C.) (RT being an abbreviation for room temperature). In another embodiment, when the asphalt is included in an amount within a range of from about 5% to about 15% by weight of the product, it is estimated the product retains at least about 75% of the properties noted above, the retention being somewhat proportional to the percentage of asphalt. These properties can be measured by any suitable methods, for example by the following: tensile stress and tensile modulus according to ASTM D638; and flex stress RT, flex stress 0° F. (−18° C.), flex modulus RT and flex modulus 0° F. (−18° C.) according to ASTM D790. While a polypropylene resin has exhibited the above properties, one skilled in the art appreciates that these properties may vary somewhat depending upon the resin selected.

The addition of the asphalt may improve one or more physical properties of the product in some embodiments. For example, the impact properties of the product may be improved. In a preferred embodiment, when the asphalt is included in an amount greater than 0.5%, and also within a range of from about 0.5% to about 10% by weight of the product, the product has an improvement in unnotched impact of at least about 10%, preferably at least about 20%, compared to the same product without the asphalt. One skilled in the art appreciates that an improvement will be achieved at almost any level of asphalt addition, however the magnitude will vary depending on the resin, asphalt and other factors. The unnotched impact can be measured by any suitable method, such as ASTM 4812 or ASTM D256.

Certain types of asphalt are preferred for use as a colorant or a resin replacement in a resin based product. The asphalt used as a colorant is preferably an asphalt flux, a paving grade asphalt, or a mixture thereof. The asphalt used as a resin replacement is preferably a hard asphalt, a paving grade asphalt, or a mixture thereof.

An asphalt flux or straight-run asphalt is the residuum (heated sufficiently to flow) that results from the atmospheric and vacuum distillation processes at petroleum refineries and asphalt manufacturers. Asphalt flux is often used in the manufacture of asphalt roofing products such as saturant asphalts and some modified bitumen products. Asphalt flux is also used as a feedstock in the air-blowing process for making oxidized roofing asphalt.

A paving grade asphalt, also called an asphalt cement or a road grade asphalt, is a relatively soft and flowable asphalt that is often used with aggregate as a binder for paving roads. The paving grade asphalt meets the requirements of at least one of the ASTM D3381-05 specification for viscosity-graded asphalt cement for use in pavement construction, and the ASTM D946-82 (2005) specification for penetration-graded asphalt cement for use in pavement construction. A paving grade asphalt usually has a softening point within the range of from about 150° F. (66° C.) to about 185° F. (85° C.) and a penetration within the range of from about 40 dmm to about 300 dmm. Softening point can be measured by any suitable method, such as the ring and ball softening point typically measured according to ASTM D36. Penetration can also be measured by any suitable method, such as by the ASTM D5-05a method for measuring the penetration of bituminous materials. Paving grade asphalt or asphalt cement is commonly abbreviated with the terms AC-xx asphalt where “xx” is a numeral related to the asphalt viscosity, with smaller numbers being less viscous and larger numbers being more viscous. Paving grade asphalts can range in viscosity, for example, from AC-1.75 to AC-120.

A hard asphalt has a low penetration compared to the other types of asphalt. The penetration is usually not greater than about 20 dmm, preferably not greater than about 15 dmm, and more preferably not greater than about 10 dmm. Some preferred hard asphalts are solvent extracted asphalts. Solvent extraction techniques are well-known typically employ the use of a C3-C5 alkane, usually propane. These techniques are variously referred to as deasphalting or as producing a propane deasphalted asphalt (PDA), a propane washed asphalt (PWA), or a propane extracted asphalt (PEA). Typically such techniques involve treating normal crude oil and/or vacuum residue feedstock with such alkanes whereby a treated asphalt is obtained in which the level of saturates, compared to the originally treated material, is decreased and the levels of asphaltenes and resins are increased. Exemplary of the solvent extracted asphalts is Shell PDA which typically has a penetration from about 1 dmm to about 18 dmm, and Sun Oil PWA which typically has a penetration from 0 dmm to about 10 dmm.

The selection of the type of asphalt used as an colorant and/or resin replacement in a resin based product may be affected by the saturates level of the asphalt. In general, it is preferred that the asphalt have a saturates level of no more than 20 wt %, and preferably no more than 15 wt %, and even more preferably less than about 10 wt %. The saturates level of the asphalt can be determined in any suitable manner, such as Corbett Analysis. Lower saturates levels are preferred when the asphalt is used as a resin replacement versus as a colorant.

In some embodiments of the invention, it is preferred to use an oxidized asphalt. An oxidized asphalt is asphalt treated by blowing air, oxygen or an oxygen-inert gas mixture through the asphalt at an elevated temperature for a time sufficient to harden the asphalt to the desired physical properties. One skilled in the art appreciates that oxidation of the asphalt may be improved through the use of catalysts and/or additives during the blowing process, such as taught in U.S. Pat. No. 4,659,389, which is incorporated herein by reference in its entirety. The use of an oxidized asphalt may provide one or more product advantages. For example, oxidizing the asphalt may improve the physical properties of the product. An oxidized asphalt may also be more effective as a colorant. Oxidizing the asphalt to increase its softening point may also prevent the occurrence of blooming, which is the migration of oil from the asphalt to the surface of the product that detracts from the feel and appearance of the product.

The asphalt for use as a resin replacement or a colorant in a resin based product preferably has a softening point of at least about 150° F. (66° C.), more preferably within a range of from about 150° F. (66° C.) to about 350° F. (176° C.), more preferably from about 200° F. (93° C.) to about 350° F. (176° C.), and most preferably from about 250° F. (121° C.) to about 300° F. (148° C.). In general, a more highly oxidized asphalt having a higher softening point results in better physical properties of the product.

The colorant properties of the asphalt may also be affected by its sulfur content. In general, the higher the sulfur content of the asphalt, the darker the color of the blend of resin and asphalt, especially if the asphalt is an oxidized asphalt. In one embodiment, it is preferred that the asphalt have a sulfur content of at least about 2 wt %, and more preferably at least about 3 wt %.

When the asphalt is used as a colorant and/or a resin replacement in a resin based product, it is preferably included in an amount to achieve the desired color and/or replacement without significantly impacting the physical properties of the product, or providing a compound which meets the physical property requirements of the product. For use as a colorant and/or a resin replacement, the asphalt is preferably included in an amount within a range of from about 0.1% to about 40% by weight of the compound. When the asphalt is used as a colorant, the amount of asphalt used is dependent upon a number of factors, including the thickness of the product, the desired blackness of the product, the resin used, the desired physical properties and appearance of the product, and the cost of the compound. Asphalt is generally preferably included as a colorant in an amount within a range of from about 0.5% to about 30% by weight of compound, however in certain applications the percentage of asphalt is more preferably from about 1% to about 20%, in other applications more preferably from about 1% to about 10%, in certain other applications preferably about 1% to about 5%, and in certain other applications more preferably about 2.5 to 5%. When the asphalt is used as a resin replacement, the percentage of asphalt varies due to similar factors as noted above for the colorant, and generally asphalt is preferably included in an amount within a range of from about 1% to about 40% by weight of the compound, in certain applications it is more preferably from about 5% to about 40%, and in certain other applications more preferably from about 10% to about 40%. Generally the amount of asphalt used is optimized according to the product requirements, materials used, processes, and the desire to minimize costs, which generally tends to maximize the amount of asphalt while maintaining the other criteria.

In a particular embodiment, the invention relates to a compound for manufacturing a resin based product including a blend of asphalt and resin, where at least part of the asphalt is sourced from reclaimed asphalt roofing material. Preferably, at least about 50 wt % of the total asphalt is sourced from the reclaimed asphalt roofing material, and more preferably substantially all of the asphalt is obtained from this source. The reclaimed asphalt can function as a colorant and/or a resin replacement in the product depending on the level added. In another embodiment, the recycled shingle material may be added to the process as a separate input material to make the product directly either in ground, pelletized or any other form suitable for the equipment being used, versus being blended in a compound prior to feeding.

The reclaimed asphalt roofing material includes waste material from a roofing material manufacturing process, such as cut out tabs that are removed and discarded or other shingle manufacturing scrap, shingles that are of lesser quality, or “seconds”. Additionally, the reclaimed material may include old roofing material such as tear-off shingles that have been removed from buildings. The roofing material can be roofing shingles, rolled roofing membranes, or any other type of asphalt-containing roofing material. Any suitable method can be used for recycling/reclaiming the material, such as the methods disclosed in U.S. Pat. Nos. 4,222,851, 5,626,659, 5,848,755 and 6,228,503 and US Publication 20020066813, which are incorporated by reference herein, or any method to provide particles or liquid recycled material compatible with the present invention. For example, reclaimed roofing shingles may include about 20% asphalt that has been oxidized and hardened to an extent desirable for use in the present invention. The reclaimed shingles also usually include glass fibers, roofing granules, and filler such as ground limestone or other rock. These materials can function as reinforcements or fillers in the resin based product, or be removed prior to introduction into the compound

The recycling process usually includes a step of grinding the material. This may produce a granular or powdered material that does not require further compounding or treatment prior to use. In one embodiment, the reclaimed asphalt roofing material is ground to a maximum particle size of less than about 0.0331 inch (0.084 cm), and preferably less than about 0.0117 inch (0.030 cm).

In another embodiment of the invention, ground asphalt is blended with resin to form the compound for forming the resin based product. The ground asphalt can be ground asphalt alone or ground reclaimed asphalt roofing material. Optionally, other materials suitable for use in the compound can also be blended with the resin and ground asphalt. In a particular embodiment, the ground asphalt is preblended or added with the resin at the feedthroat of the extruder or injection molding machine thereby producing the compound in the extruder or injection molding machine. This provides the required compounding in-situ to the product manufacturing.

The resin blended with the asphalt can be any type suitable for producing a resin based product. The term “resin”, as used herein, means a pseudosolid or solid organic material often of high molecular weight, having a tendency to flow when subjected to stress, usually having a softening or melting range, and usually fractured conchoidally. Some preferred resins for use in the invention are polymers, in particular thermoplastic polymers. Some examples of suitable polymers include polypropylene (PP), polyethylene (PE), polystyrene (PS), polyphenylene oxide, polyacetal, polybutylene terephthalate, polymethyl methacrylate, polyvinyl acetate, acrylonitrile-butadiene-styrene (ABS), acrylonitrile-styrene-acrylate (ASA), polycarbonate, polyvinyl chloride (PVC), polyether sulfone, polyether ketones and copolymers and/or mixtures thereof. Any of the different types of polyethylene can be used, such as high density polyethylene (HDPE), low density polyethylene (LDPE) or linear low density polyethylene (LLDPE). In one embodiment, it is preferred to use polypropylene, polyethylene, or a copolymer and/or mixture thereof. Some examples of suitable commercial polypropylene homopolymers are Profax 6323 and Profax 6523 manufactured by Himont USA, Inc., St. Charles, La. An example of a suitable commercially available polyethylene/polypropylene copolymer is Maxxam PD6201 manufactured by PolyOne, of Avon Lake, Ohio.

In other embodiments, the invention relates to asphalt/resin pellets for use in the above-described compound for manufacturing a resin based product. The pellets include a blend of asphalt and resin, and they may also include any of the optional materials described above for use in the compound. In some embodiments the pellets include all the materials necessary for producing the compound, and in other embodiments one or more materials are added to the pellets for producing the compound. Preferably, the pellets include all the necessary materials for the compound except perhaps for some additional resin that can be added by the resin based product manufacturer.

The term “pellets”, as used herein, includes a combination of asphalt and resin in solid form, e.g., in the form of pellets, granules, flakes, particles, powders, or other formed shapes. The pellets can be any shape and size suitable for their intended use. For example, the pellets can be generally spherical or generally cylindrical in shape, and they can range in size from very small to very large. Preferably, the pellets are sized and shaped so that they have good flow properties when transported and handled with most processing equipment for manufacturing resin based products. For example, preferably the pellets are free flowing and substantially nondusting to work effectively in pneumatic transport systems that may be used to handle the pellets during a manufacturing process.

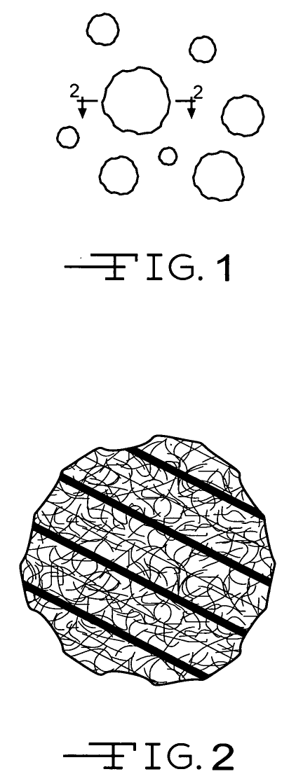

FIGS. 1 and 2 illustrate some examples of asphalt/resin pellets 10, 12 and 14 that can be made according to the invention. The pellets shown are generally spherical in shape, but they could also be other shapes as described above. Several different sized pellets are shown for illustration purposes, but they could also be similar or substantially identical in size. In one embodiment, the pellets are generally spherical in shape with a diameter from about 1/32 inch (0.079 cm) to about ½ inch (1.27 cm), and preferably from about 1/16 inch (0.159 cm) to about ¼ inch (0.635 cm). The pellet size is based on the needs of the processing equipment in which the pellet will be further processed, typically an injection molding machine.

The asphalt/resin pellets can have any composition suitable for use in a compound for manufacturing a resin based product. In addition to the asphalt and resin derived from the pellets, the compound may also include other asphalt and/or resin added separately to the compound. In one embodiment, the pellets are melted and mixed with melted resin to make the compound. Preferably, the pellets mix readily with the melted resin in the processing equipment thereby producing an end product that is uniform in nature and appearance. The pellets when added to the processing equipment may melt quicker and disperse faster than alternative colorants/resin replacements prepared using carbon black; lower temperature and power requirements for mixing may result.

The pellets can include any suitable amounts of asphalt and resin. For example, the pellets may comprise from about 40% to about 95% asphalt and from about 5% to about 60% resin by weight of the pellet, typically from about 60% to about 95% asphalt and from about 5% to about 40% resin, and sometimes from about 60% to about 80% asphalt and from about 20% to about 40% resin.

The asphalt for use in the asphalt/resin pellets is preferably an oxidized asphalt. It is also preferred that the asphalt have a softening point within a range of from about 200° F. (93° C.) to about 350° F. (176° C.), and more preferably from about 250° F. (121° C.) to about 300° F. (148° C.).

Preferably, the composition, size and shape of the asphalt/resin pellets are selected so that they do not block during manufacture of the compound; i.e., they do not adhere together and/or to the manufacturing equipment and block the flow of the pellets and/or other materials through the equipment. The pellets preferably do not adhere together and do remain flowable when they are stored at a temperature of 120° F. (49° C.) for 30 days. The pellets may include additional materials, such as those described in the first paragraph of the detailed description, or any other materials used to make resin based products as known to one skilled in the art.

The pellets and/or the compound may include at least one reinforcement material selected from natural and synthetic fibrous reinforcements, mineral reinforcements, nanomaterial reinforcements, and combinations thereof. The inclusion of a reinforcement material may improve the properties of the resin based product. The pellet 10 shown in FIG. 2 includes glass fiber reinforcements 16 dispersed in a matrix 18 of asphalt and resin.

Natural fibrous reinforcements can include, for example, natural fibers such as sisal, hemp, jute, and many other kinds of natural fibers, so long as the fibers will not burn at the high processing temperatures used to make the resin based product.

Synthetic fibrous reinforcements can include, for example, mineral fibers, polymer fibers, carbon fibers, cellulose fibers, and rag fibers. Suitable mineral fibers may include fibers of a heat-softenable mineral material, such as glass, ceramic, rock, slag or basalt. The mineral fibers can be in any suitable form, such as chopped strands (e.g., wet use or dry use chopped strands), wool (e.g., glass wool or rockwool), or rovings. When wet chopped strands are added to the molten asphalt and/or molten resin, the molten material drives off the moisture from the strands and the moisture is then vented from the molten mixture.

Mineral reinforcements can include, for example, glass microspheres, silica, mica, and talc, calcium carbonate, wollastonite, or any other known mineral reinforcement.

More generally, the invention relates to a composition comprising a blend of asphalt, resin and a nanomaterial. The term “nanomaterial”, as used herein, includes any type of materials that are known as nanomaterials to persons of ordinary skill in the art, including currently known or future developed materials. The nanomaterials are not limited by their particle size, particle size distribution or type of material. For example, nanomaterials are sometimes described in the literature as particles (or fibers, platelets, etc.) that are less than 100 nanometers in at least one dimension. Nanomaterial sized particles are often interspersed with larger particles, and such materials are included in this invention. The incorporation of the nanomaterial in the asphalt/resin blend may produce compositions having enhanced physical properties. Any type of composition suitable for the inclusion of any type of nanomaterial(s) can be produced. For example, the composition can be used in a compound for manufacturing a resin based product, as described above. Optionally, other materials suitable for use in a compound can be included.

Any suitable nanomaterials can be used in the composition, such as any suitable nanomaterial reinforcements and/or fillers. The terms “nanoreinforcement” and “nanofiller” are often used interchangeably in the literature. Some suitable nanomaterials include, for example, isodimensional (3-D) nanoparticles such as spherical silicas, calcium carbonate nanoparticles and so on; 2-dimensional nanoparticles such as nanotubes and cellulose whisker; and 1-dimensional nanoparticles such as nanoclays, nanographites, layered double hydroxides, nanotalcs and so on. Some specific examples are nanoclays, carbon nanofibers, carbon nanotubes, POSS® Chemicals, and fullerene nanotubes. These reinforcements may have at least one dimension in the nanometer range, e.g., less than 1 nanometer up to about 5 nanometers. A nanoclay is a clay from the smectite family having a unique morphology, featuring one dimension in the nanometer range. The nanoclay may be described as consisting of extremely fine platelets, each having a high aspect ratio and large surface area. Montmorillonite clay is the most common nanoclay. Carbon nanofibers are cylindric nanostructures with graphene layers arranged as stacked cones, cups or plates. Carbon nanofibers with graphene layers wrapped into perfect cylinders are called carbon nanotubes. The carbon nanotubes can be single-walled or multi-walled. The carbon nanofibers/nanotubes are long and thin, typically about 1-3 nanometers in diameter and hundreds to thousands of nanometers long. POSS® Chemicals are nano-sized molecules derived from polyhedral oligomeric silsesquioxanes and polyhedral oligomeric silicates. Fullerene nanotubes, or “Buckytubes”, are polymer molecules that self-assemble into a network of ropes or bundles within a host polymer.

The composition can include any suitable types of asphalt and resin blended with the nanomaterial, such as those described above or others. In one embodiment, the composition includes a preblended mixture of resin and nanomaterial, which is subsequently blended with the asphalt and sometimes additional resin. Some examples of suitable commercial products are the Nanoblend™ Concentrates, manufactured by PolyOne Corp., Avon Lake, Ohio, which are blends of 40% exfoliated nanoclay well dispersed in a matrix of polypropylene or polyethylene.

The nanomaterials can be incorporated into the resin/asphalt formulations by any suitable method, for example by any of the following: (1) The resin/asphalt melt is blended with a resin/nanomaterial preblend (e.g., a Nanoblend™ Concentrate). (2) The resin and asphalt are blended with the nanomaterial, either during or after the preparation of the resin/asphalt blend. (3). The nanomaterial is blended with the asphalt, and then the resin is blended with the asphalt/nanomaterial blend. For example, the nanomaterial can be added to an asphalt emulsion. (4) Asphalt is blended with a resin/nanomaterial preblend.

The asphalt, resin and nanomaterial can be included in the composition in any suitable amounts. In some embodiments, the composition includes asphalt in an amount within a range of from about 0.1 wt % to about 40 wt %, resin in an amount within a range of from about 40 wt % to about 99.8 wt %, and nanomaterial in an amount within a range of from about 0.1 wt % to about 20 wt %. When the nanomaterial is a nanoclay, it is usually preferred to included it an amount within a range of from about 1% to about 12%. For example, blends of 5/92/3, 12/85/3, and 19/78/3 asphalt/polypropylene/nanoclay (in wt %) produced products having desirable mechanical properties in terms of tensile stress, flex stress, tensile modulus, and flex modulus. Notched and unnotched IZOD impact may also be improved. In some embodiments, one or more of these properties are improved by at least about 20%, preferably at least about 35%, compared to the same product without the nanomaterial.

The compound of the invention can be manufactured by any suitable method. The manufacturing process involves melting the asphalt, resin and any other meltable materials in the compound, and blending the materials together to make the compound. Any suitable order of melting and blending, and any suitable equipment, can be used. For example, the process may involve melting the asphalt, and mixing the molten asphalt with resin to form a molten asphalt/resin blend. In a preferred embodiment, an extruder is used for blending the materials and for melting at least some of the materials. Any suitable type of extruder can be used, such as a single or twin screw compounding extruder (e.g., a single screw compounding extruder/pelletizer manufactured by Prodex Corp., Fords, N.J.). In one embodiment, the resin is fed into the extruder and is melted within the extruder, and molten asphalt is fed into the extruder downstream of the molten resin and blended with the resin. In a particular embodiment, a wet reinforcement material, such as wet use chopped strands of glass, is fed into the extruder and moisture from the reinforcement material is vented downstream of at least one of the melting of the resin and the feeding of the molten asphalt.

Optionally, one or more materials of a lower melt flow than asphalt can be combined with the asphalt during the compound manufacturing process to facilitate flow of the combined materials through the manufacturing equipment. Any suitable material(s) can be used, such as waxes, lubricants, process aids and such.

In a preferred embodiment, the compound manufacturing process is conducted at an asphalt manufacturing site. An asphalt manufacturing site has asphalt in a molten state, such as asphalt which has undergone an air-blowing (oxidizing) process. This molten asphalt can be introduced into the compound manufacturing process. For example, the molten asphalt from the air-blowing process can be fed into the compounding extruder and blended with the molten resin. By introducing that molten asphalt into the compound manufacturing process, the heat used in the asphalt manufacturing process can effectively be recovered in the compound manufacturing process. Only the heat needed to melt the resin is then required, thus making the compound manufacturing process energy efficient.

After the materials of the compound are melted and blended, the compound is usually formed and cooled to produce solid pieces suitable for shipping to a resin based product manufacturer. In a preferred embodiment, the compound is formed into pellets as described above. Any suitable pelletizing equipment can be used to form the pellets. The pelletizing equipment usually involves extruding the compound under heat and pressure to form pellets which are then cooled. In a preferred embodiment, the pelletizing equipment is installed in the manufacturing line directly downstream of the compounding extruder. For example, the above-mentioned Prodex extruder includes a pelletizer connected directly downstream of a compounding extruder.

The compound of the invention can be used by a resin based product manufacturer to form a wide variety of different products. The compound can be readily mixed with additional resin under normal processing conditions. Any suitable manufacturing process can be used, such as injection molding, blow molding or extrusion. In a typical injection molding process, the asphalt/resin pellets and additional resin are combined and heated with mixing to produce a melt. Then the melt is forced into a split-die mold where it is allowed to cool into the desired shape. The mold is then opened and the product is ejected, at which time the cycle is repeated.

The asphalt/resin compound has improved flow in processing equipment for resin based products compared to the same compound including the resin and not the asphalt. This lowers the energy requirements of the manufacturing process.

The asphalt as a colorant and/or resin replacement can be used in many different applications. Some anticipated optimal applications are the use in large resin based products where material is a significant component of unit cost, and the use in cost sensitive product lines. Potential markets include industrial, commercial, agricultural and/or residential customers. Typically the pellets and/or compound may be used in any known process and equipment to manufacture thermoplastic parts, such as injection molding, extruding, rotational molding, thermoforming, blow molding, and other known processes. Furthermore, it is contemplated that the composition may have other uses, such as applied as a sound deadener.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A compound comprising a combination of materials for manufacturing a resin based product, the materials including a solid blend of asphalt and resin, the asphalt functioning as at least one of a colorant to change the color of the product and a resin replacement to reduce the amount of resin in the product, the asphalt when used as a resin replacement having a penetration of not greater than about 15 dmm at 25° C., and the asphalt being included in an amount within a range of from about 0.1% to about 40% by weight of the compound.

2. The compound of claim 1 wherein the asphalt has a saturates level of no greater than about 20 wt %.

3. The compound of claim 1 wherein the asphalt has a softening point within a range of from about 150° F. (66° C.) to about 350% (176° C.).

4. The compound of claim 1 wherein the asphalt functions as a colorant.

5. The compound of claim 4 wherein the asphalt is an asphalt flux, a paving grade asphalt, or a mixture thereof.

6. The compound of claim 4 wherein the asphalt is included in an amount within a range of from about 0.1% to about 20% by weight of the compound.

7. The compound of claim 6 wherein the asphalt is included in an amount within a range of from about 0.1% to about 10% by weight of the compound.

8. The compound of claim 6 wherein the asphalt is included in an amount within a range of from about 0.5% to about 5% by weight of the compound.

9. The compound of claim 4 wherein the blend of resin and asphalt has a CIE L* color not greater than about 35, an a* color not greater within a range of from about −10 to about 10, and a b* color within a range of from about −10 to about 10.

10. The compound of claim 9 wherein the blend of resin and asphalt has a CIE L* color within a range of from about 1.5 to about 30, an a* color within a range of from about −5 to about 5, and a b* color within a range of from about −5 to about 5.

11. The compound of claim 9 wherein the blend of resin and asphalt has a CIE L* color within a range of from about 24 to about 27 when measured in a product having a thickness of 0.125 inch.

12. The compound of claim 1 wherein at least part of the asphalt is sourced from reclaimed asphalt roofing material.

13. The compound of claim 1 which additionally comprises at least one reinforcement material selected from natural and synthetic fibrous reinforcements, mineral reinforcements, nanomaterial reinforcements, and combinations thereof.

14. The compound of claim 1 wherein the asphalt functions as a resin replacement.

15. The compound of claim 14 wherein the asphalt is a hard asphalt, a paving grade asphalt, or a mixture thereof.

16. The compound of claim 14 wherein the asphalt is included in an amount within a range of from about 5% to about 40% by weight of the compound.

17. The compound of claim 14 wherein the product with the asphalt as a resin replacement retains its physical properties, compared to the same product without the asphalt as a resin replacement, such that when the asphalt is included in an amount within a range of from about 5% to about 15% by weight of the product, the product retains at least about 75% of the following physical properties: tensile stress, tensile modulus, flex stress RT, flex stress 0° F. (−18° C.), flex modulus RT, and flex modulus 0° F. (−18° C.).

18. The compound of claim 14 wherein the product with the asphalt as a resin replacement has an unnotched impact that is improved by at least about 10% compared to the same product without the asphalt as a resin replacement, when the asphalt is included in an amount greater than about 0.5% by weight of the product.

19. A compound comprising a combination of materials for manufacturing a resin based product the materials including a blend of asphalt and resin, the asphalt functioning as at least one of a colorant to change the color of the product and a resin replacement to reduce the amount of resin in the product, and at least part of the asphalt being sourced from reclaimed asphalt roofing material.

20. The compound of claim 19 wherein the asphalt is reclaimed from at least one of shingle manufacturing scrap, shingle seconds, and tear-off shingles.

21. The compound of claim 19 wherein the reclaimed asphalt roofing material is ground to a maximum particle size of less than about 0.0331 inch (0.084 cm).

22. The compound of claim 21 wherein the reclaimed asphalt roofing material is ground to a maximum particle size of less than about 0.0117 inch (0.030 cm).

23. A compound comprising a combination of materials for manufacturing a resin based product, the materials including a blend of asphalt and resin, at least part of the asphalt and the resin being derived from pellets comprising the asphalt and the resin.

24. The compound of claim 23 wherein the pellets comprise from about 40% to about 95% asphalt and from about 5% to about 60% resin by weight of the pellet.

25. The compound of claim 23 wherein the asphalt has a saturates level of not more than about 20 wt %.

26. The compound of claim 23 wherein the asphalt has a saturates level of not more than about 15 wt %.

27. The compound of claim 23 wherein the asphalt has a softening point within a range of from about 150° F. (66° C.) to about 350° F. (176° C.).

28. A pellet for use in a compound comprising a combination of materials for manufacturing a resin based product, the pellet comprising from about 40% to about 95% asphalt and from about 5% to about 60% resin by weight of the pellet, the asphalt having a softening point within a range of from about 150° F. (66° C.) to about 350° F. (176° C.).

29. The pellet of claim 28 which comprises from 60% to about 80% asphalt and from about 20% to about 40% resin.

30. The pellet of claim 28 wherein the asphalt has a saturates level of not more than about 20 wt %.

31. The pellet of claim 28 which additionally comprises at least one reinforcement material selected from natural and synthetic fibrous reinforcements, mineral reinforcements, nanomaterial reinforcements, fillers, process aids, lubes, pigments, dyes, carbon blacks, UV inhibitors, compatibilizers, and combinations thereof.

32. A pellet for use in a compound comprising a combination of materials for manufacturing a resin based product, the materials including a blend of asphalt and resin, at least part of the asphalt being sourced from reclaimed asphalt roofing material.

33. A process of for g a resin based product comprising providing pellets comprising asphalt and resin, using the pellets to form a compound which comprises a combination of materials for molding the product, and forming the compound into the product.

34. The process of claim 33 wherein the pellets comprise from about 40% to about 95% asphalt and from about 5% to about 60% resin by weight of the pellet.

35. The process of claim 33 wherein the asphalt has a softening point within a range of from about 150° F. (66° C.) to about 350° F. (176° C.).

36. The process of claim 33 wherein the compound is used to manufacture the product in processing equipment, the compound having improved flow in the processing equipment thereby lowering the energy requirements of the manufacturing process compared to the same compound including the resin and not the asphalt.

37. A process of forming a resin based product comprising blending resin and ground asphalt to form a compound which comprises a combination of materials for forming the product, and forming the compound into the product.

38. A process of manufacturing asphalt/resin pellets comprising the steps of:
(a) melting asphalt;
(b) mixing the molten asphalt from step (a) with resin to form a molten blend of asphalt and resin; and
(c) forming the molten blend of asphalt and resin into asphalt/resin pellets.

39. The process of claim 38 wherein the resin is fed into an extruder and is melted within the extruder, and wherein the mixing step (b) is conducted by feeding the molten asphalt into the extruder downstream of the molten resin.

40. The process of claim 39 wherein wet chopped glass fibers are fed into the extruder and moisture from the wet fibers is vented downstream of at least one of the melting of the resin and the feeding of the molten asphalt.

41. The process of claim 38 wherein wet chopped glass fibers are fed into the molten asphalt and moisture from the wet fibers is vented after the fibers are added to the molten asphalt.

42. The process of claim 38 wherein the asphalt is melted in step (a) in an oxidizing process.

43. A composition comprising a solid blend of about 0.1 wt % to about 40 wt % asphalt, about 40 wt % to about 99.8 wt % resin and about 0.1 wt % to about 20 wt % nanomaterial, the nanomaterial increasing the flex modulus of the composition by at least about 20% compared to the same composition without the nanomaterial.

44. The composition of claim 43 wherein the nanomaterial is a nanoclay.

45. The composition of claim 43 which is a compound for manufacturing a resin based product.

46. The composition of claim 43 which is in the form of a pellet.

47. A composition comprising a blend of asphalt and resin, the composition having a color which is not black.

48. The composition of claim 47 further comprising a coloring additive.
